(19) United States
(12) Patent Application Publication
(10) Pub. No.: US 2013/0106218 A1
(43) Pub. Date: May 2, 2013

(54) ELECTRIC MACHINE COMPRISING AN IMPROVED TERMINAL BOX

(71) Applicant: Patrick Vohlgemuth, Marillac Le Franc (FR)

(72) Inventor: Patrick Vohlgemuth, Marillac Le Franc (FR)

(73) Assignee: MOTEURS LEROY-SOMER, Angouleme (FR)

(21) Appl. No.: 13/634,742

(22) PCT Filed: Mar. 22, 2011
(86) PCT No.: PCT/IB2011/051200

§ 371 Date: Dec. 28, 2012

Related U.S. Application Data
(60) Provisional application No. 61/318,423, filed on Mar. 29, 2010.

(30) Foreign Application Priority Data
Mar. 24, 2010 (FR) 1052136

(51) Int. Cl. H02K 5/22

(52) U.S. Cl. CPC H02K 5/225
USPC 310/89

(57) ABSTRACT

An electric machine including a casing and a terminal box attached to the casing. The terminal box includes two half-shells that are assembled one against the other, the half-shells being identical before they are made to form one or more cable ducts by the removal of one or more detachable portions provided for this purpose.

The present invention relates to electric machines and more particularly those fitted with terminal boxes making it possible to connect them to electric cables outside the machine, and even to house a regulator or optionally a variator.

The terminal boxes are usually fixed to the casing of the machine, notably on the upper portion.

U.S. Pat. No. 6,002,083 describes a terminal box formed by the assembly of two shells of which one comprises a first opening for the cable run to the outside of the machine and a second opening to the inside of the machine.

Canadian application CA 85 33 79, French patent FR 1 092 897, French patent application FR 2 778 796, British application GB 2 340 673, Japanese applications JP 05-083899 and JP 57 025 133 and U.S. Pat. No. 5,192,888 and U.S. Pat. No. 5,769,659 describe other examples of terminal boxes.

There is a need to further simplify the manufacture of electric machines.

The invention achieves this, according to one of its aspects, by virtue of an electric machine comprising:
a casing,
a terminal box, fixed to the casing,
   the terminal box comprising two half-shells assembled one against the other, these half-shells being identical before formation of one or more cable runs by removal of one or more removable portions provided for this purpose.

The use of identical half-shells simplifies manufacture since only one mold imprint may be used.

Moreover, an operator can gain access to the content of the terminal box without having to touch the cables, by removing the half-shell that is not traversed by the cables, which is advantageous from the point of view of maintenance and safety.

Advantageously, each of the half-shells is provided with a female portion and with a male portion which interact respectively with the male portion and female portion of the other half-shell, when the two half-shells are assembled to form the terminal box.

These male and female portions may notably make it possible to achieve a more hermetic closure of the terminal box while ensuring the precise positioning of the contact edges of the half-shells.

Except for the male and female portions, each half-shell can have a symmetrical shape relative to a transverse mid-plane of symmetry for the half-shell.

Each male portion comprises, for example, a tongue forming a protrusion which covers the top and the side of the other half-shell.

The end of the tongue adjacent to the transverse mid-plane of the terminal box may extend obliquely at 45° relative to the longitudinal axis of the tongue, in a preferred exemplary embodiment, so that each tongue is positioned without discontinuity in line with the other tongue.

According to another advantageous feature of the invention, each of the half-shells initially, that is to say when it comes out of the mold that has been used to produce it, has no open run for the cables outside the machine. Preferably, the run or runs for the cables outside the machine are produced by removing one or more removable portions. This or these removable portions are each delimited by a thinned zone made during the molding of the half-shells. The thinned zones extend for example for each half-shell on two sets of concentric circles, each set being symmetrical with the other relative to a transverse mid-plane for the half-shell.

The fixing of the two half-shells together can be carried out for example by screw/nut systems, the screws preferably being mounted in a captive manner on the corresponding half-shell. The half-shells may be made with grooves allowing the passage of a tool for tightening these screws. The presence of these grooves may help to stiffen the half-shells, and to allow the terminal box to withstand accidental mechanical stresses despite the terminal box being made of thermoplastic.

The casing may be fixed at the bottom to a plinth, by means of fixing legs, which may be two in number, identical to one another.

Each half-shell may comprise two sets of concentric thinned zones making it possible, when severed, to create a cable run of the desired diameter.

Each half-shell may comprise longitudinal grooves making it possible to engage therein a tool for tightening the screws.

Each half-shell may comprise two uprights delimited by a circular edge suitable for closely matching the shape of the casing of the machine.

The interface between the two half-shells may extend substantially on a plane containing the axis of rotation of the machine.

The invention can be better understood on reading the following detailed description of exemplary, nonlimiting, embodiments of the latter, and on examining the appended drawing in which:

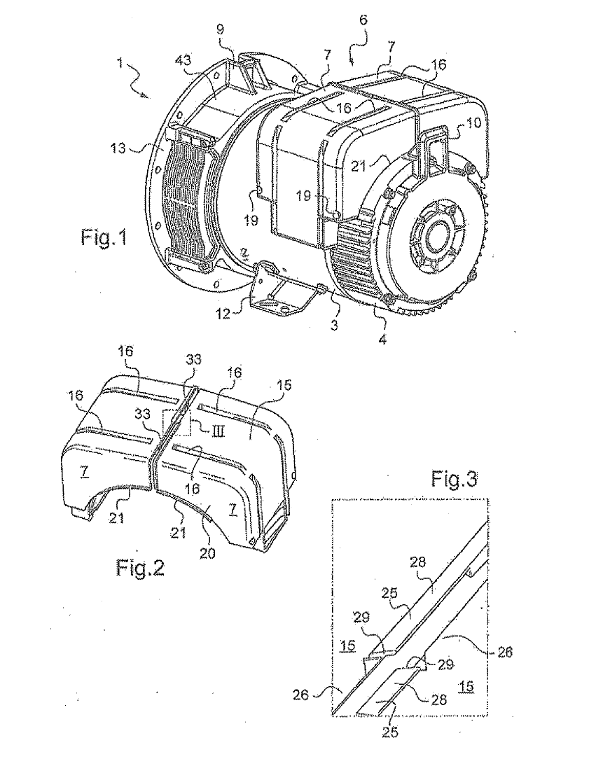

FIG. 1 represents schematically and in perspective an example of an electric machine produced according to the invention,

FIG. 2 represents in isolation the two half-shells of the terminal box before assembly,

FIG. 3 represents the detail III of FIG. 2,

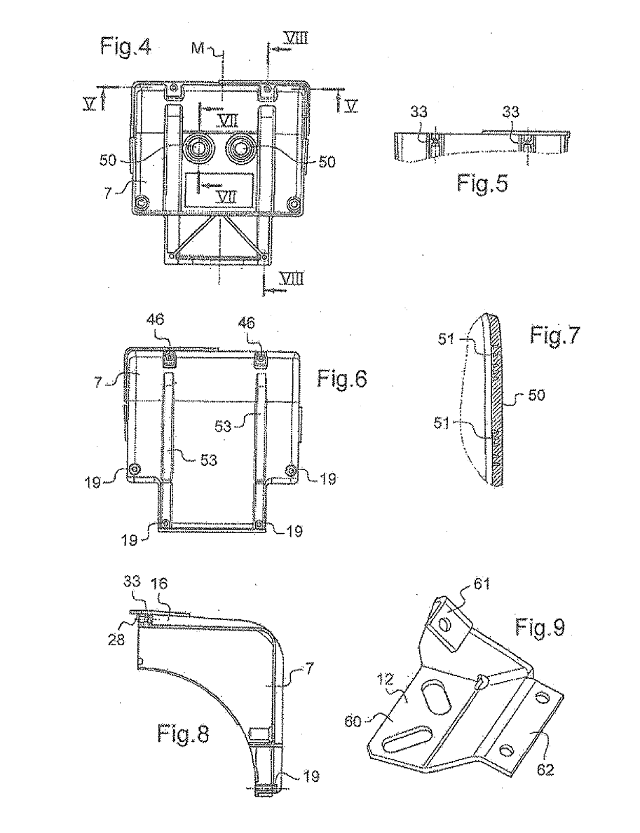

FIG. 4 represents in isolation the inside of one half-shell of the terminal box,

FIG. 5 is a section along V-V of FIG. 4,

FIG. 6 represents externally, from the front, one half-shell of the terminal box,

FIG. 7 is a section along VII-VII of FIG. 4,

FIG. 8 is a section along VIII-VIII of FIG. 4, and

FIG. 9 represents in isolation a fixing leg of the machine.

Represented in FIG. 1 is an electric machine 1 which is for example a motor or a generator and which comprises a metal casing 2 made for example by aluminum injection. The casing 2 may be fixed to a plinth, not shown, by fixing legs 12.

The casing 2 comprises a carcass 3, for example of generally cylindrical shape, which houses the stator of the machine, on which a front flange 43 and rear flange 4 are fitted.

The machine 1 comprises a terminal box 6 comprising two identical half-shells 7, assembled to the casing 2 and together.

These two half-shells 7 are made with a single mold, preferably of thermoplastic, for example of polypropylene, preferably comprising a mineral filler, for example more than 15% by weight of talc, notably 20%, and initially have no open cable runs.

The machine 1 may comprise, at the front, a flange 13 for fixing it to a heat engine designed to drive it, when it constitutes an alternator.

The front flange 43 and rear flange 4 may comprise respective lifting rings 9 and 10.

Each half-shell 7 comprises an upper wall 15, provided with longitudinal grooves 16, which, in the example in question, are oriented transversely to the axis of rotation of the machine and which make it possible to engage therein a screwing tool in order to fix one half-shell 7 to the other, with the aid of screws engaged through passageways 33 provided for this purpose. The grooves 16 prevent having protruding screws or nuts.

In the example in question, each half-shell 7 comprises two grooves 16 on its upper wall 15, but the invention is not limited to a particular number of grooves 16.

The upper wall 15 may be inclined relative to the horizontal plane of the electric machine 1. In particular, the upper wall 15 may be contained in a plane forming a non-zero angle with the horizontal plane of the machine. In this way it is possible to aid the stripping of the half-shell 7 from the mold and to prevent liquid, notably water, from stagnating on the upper portion 15 of the half-shell 7.

The half-shells 7 can be assembled by screw/nut systems, the nuts 46 being apparent in FIG. 6, being prevented from rotating and translating in adapted housings at the end of the grooves 16.

Each passageway 33 may have a diameter smaller than that of the screw, so that the screw remains engaged in the half-shell even when it is no longer engaged on the nut that is retained by the other half-shell.

Each half-shell 7 may comprise passageways 19 for screws for fixing to the casing 2 of the machine.

Each half-shell 7 may be made with uprights 20 that are connected to the upper wall 15, these uprights 20 being delimited at the bottom by a circular edge 21 which closely matches the cylindrical shape of the casing 2.

Each half-shell 7 comprises a male portion 25 and a female portion 26 which interact respectively with the female portion 26 and male portion 25 of the other half-shell 7.

The male portion 25 comprises, for example, as illustrated, a tongue 28 which is adapted to cover the upper wall 15 of the other half-shell 7 and an upright 20 on the side.

The tongue 28 extends from an end close to the transverse mid-plane M of each half-shell to the lower edge 21 of the corresponding upright 20.

Each tongue 28 may have, as illustrated, an edge 29 beveled at 45° at its end adjacent to the mid-plane M so that the two edges 29, by one being applied against the other, ensure the continuity of the tongues 28 at the interface between the half-shells 7.

FIG. 4 shows that each half-shell 7 may comprise removable portions 50 making it possible, when removed, to create at least one run for a cable outside the machine. These removable portions may be delimited by thinned zones 51, for example a set of concentric thinned zones 51, which may make it possible, depending on the location where the material is severed, to create a run with a diameter that is more or less large, adapted to the cable that is to come out of the terminal box. The removable portions 50 delimited by thinned zones 51 may be adapted to the fixing of a cable gland and/or an end-piece for the cable outside the machine.

FIG. 4 shows that each half-shell 7 may comprise two sets of concentric thinned zones 51 placed symmetrically to one another relative to the transverse mid-plane M for the half-shell.

FIGS. 4 and 6 show that each half-shell 7 may comprise vertical grooves 53 which help to provide a certain rigidity to the terminal box.

Represented in isolation in FIG. 9 is a fixing leg 12. It can be seen that the latter may comprise a base 60 for fixing to the plinth and two legs 61 and 62 for fixing to the casing 2 of the machine, at different heights.

The legs 12 are identical for the left and right sides of the machine.

Naturally, the invention is not limited to the example that has just been described. Notably it is possible to modify the shape of the half-shells and of the male and female portions that engage.

The expression “comprising one” must be understood to be synonymous with “comprising at least one”.

1. An electric machine comprising:
a casing,
a terminal box, fixed to the casing,
the terminal box comprising two half-shells assembled one against the other, these half-shells being identical before formation of one or more cable runs by removal of one or more removable portions provided for this purpose.

2. The machine as claimed in claim 1, each of the half-shells being provided with a female portion and with a male portion which interact respectively with the male portion and female portion of the other half-shell, when the two half-shells are assembled to form the terminal box.

3. The machine as claimed in claim 2, each male portion comprising a tongue forming a protrusion which covers the top and a side of the other half-shell.

4. The machine as claimed in claim 3, the end of the tongue adjacent to the transverse mid-plane of the terminal box extending obliquely at 45° relative to the longitudinal axis of the tongue.

5. The machine as claimed in claim 1, each of the half-shells initially having no open run for cables outside the machine.

6. The machine as claimed in claim 1, the fixing of the two half-shells being carried out by screws mounted in a captive manner on the corresponding half-shell.

7. The machine as claimed in claim 1, each half-shell comprising two sets of concentric thinned zones making it possible, when severed, to create a cable run of a desired diameter.

8. The machine as claimed in claim 6, each half-shell comprising longitudinal grooves making it possible to engage therein a tool for tightening the screws.

9. The machine as claimed in claim 1, each half-shell comprising two uprights delimited by a circular edge suitable for closely matching the shape of the casing of the machine.

10. The machine as claimed in claim 1, an interface between the two half-shells extending substantially on a plane containing the axis of rotation of the machine.
